(19) United States
(12) Patent Application Publication
(10) Pub. No.: US 2007/0263385 A1
(43) Pub. Date: Nov. 15, 2007

(54) Flexible Cable Light Capable Of Generating The Visual Effect Of Flowing Water

(75) Inventor: Ben Fan, Guangdong (CN)

Correspondence Address: HERSHKOVITZ & ASSOCIATES, 2845 DUKE STREET, ALEXANDRIA, VA, 22314, US

(73) Assignee: HE SHAN LIDE ELECTRONIC ENTERPRISE COMPANY LTD., He Shan City, Guandong (CN)

(21) Appl. No.: 11/662,796

(22) PCT Filed: Mar. 21, 2005
(86) PCT No.: PCT/CN05/00344

§ 371 Date: Mar. 14, 2007

(51) Int. Cl. F21S 4/00

(52) U.S. Cl. 362/252

(57) ABSTRACT

A flexible cable light capable of generating a visual effect of flowing water has a transparent inner coating with two strand wires, multiple circuit boards connected as a string and held in the transparent coating, and an outer transparent coating that encloses the inner coating. Each of the circuit boards has multiple LEDs, current limiting resistors and at least one LED driving chip. The power wires of circuit boards are connected to the strand wires of the inner coating. The signal wires of LED driving chips are connected in series and coupled to a controller. Each LED driving chip has a serial shift register and an outer register and provides three large driving circuits. The control signals for the flexible cable light can be enhanced and repeated by each circuit board. Therefore, the flexible cable light can be lengthened to any desired length.

### BACKGROUND OF THE INVENTION

1. Field of the Invention

The present invention relates to a flexible cable light, and more particularly to a flexible cable light that is capable of generating a visual effect of flowing water.

2. Description of Related Art

Digital control technology is widely used to control display devices, especially for the LED-based display with a large panel. These display devices can be controlled by circuits to show different patterns or texts with visual dynamic effects such as moving or chasing. By scanning columns and rows of the panel, the display is able to generate the desired patterns. However, the display with a small panel or a liner-structure is unable to generate the patterns. Therefore, a new developed LED light tube formed by multiple LED modules mounted in a translucent hard tube is proposed to generate desired visual effects. Obviously, the LED light tube is unsuitable to be cut or bent according to different application requirements. Moreover, because the control signals for the light tube, which are output from I/O terminals of a micro control unit, are of the transistor-transistor logic (TTL) voltage level, the control signals cannot be transmitted far. LED driving chips of the LED modules cannot be connected in series. In other words, the same control signal cannot be repeated along the signal wire for long-distance transmission.

Both of the LED-based display and the LED light tube use the micro control chip accompanied with LED driving chips to control each LED. However, a control signal cannot be repeated to drive all LEDs that are connected in series. To solve the problems of cutting and bending, manufacturers apply the digital control technology to control the flexible cable light and try to improve the control signal.

The China utility patent no. 200320128741.5, entitled “LED-based flexible display” discloses a flexibly display composed of multiple LED modules. However, the patent does not propose any technique to reproduce the driving signal to solve the problem of long-distance transmission, the flexible display of the patent cannot generate visual effect of flowing water either.

For the flexible cable light, although multiple lighting modules can be controlled to simultaneously turned on/off to generate flash effect or sequentially turned off to provide a chasing effect, each LED can not be separately controlled. To generate a flowing water effect superior than existed lights, each LED in the flexible light must be individually turned on/off. However, a large number of control circuits accordingly should be added in the flexible cable light. The increase of the control circuits results in a bulky and thick flexible light tube without any decoration values.

### SUMMARY OF THE INVENTION

The objective of the present invention is to provide a flexible cable light that is able to separately control each LED to generate a dynamic visual effect of flowing water, wherein control signals for the flexible cable light can be repeated to enhance the driving ability to solve the problem of long-distance transmission.

To achieve the objective, the flexible cable light comprising:

an inner coating made of flexible and transparent material and having a bottom and opposite side walls extending from the bottom, a space defined in the inner coating and communicating with a longitudinal slot that is defined through the bottom of the inner coating, two strand wires mounted in the opposite side walls; and

multiple circuit boards connected as a string with a wire bundle and held in the inner coating, each circuit board having multiple light emitting diodes (LEDs), multiple current limiting resistors and at least one LED driving chip, wherein power wires of the multiple circuit boards are connected in parallel between the two strand wires, and signal wires of the multiple circuit boards are connected in series to be further connected to a controller; and

an outer coating made of flexible and transparent material, wherein the inner coating and the multiple circuit boards are all held in the outer coating,

The LED driving chips can be connected in series and provide three large driving currents. Each LED driving chip comprises a serial shift register and an output register.

Each circuit board has main power wires. The main power wires of two adjacent circuit boards are connected in parallel to the main power wires of another two adjacent circuit boards.

Each circuit board can further have a voltage regulating resistor and a capacitor.

The LED driving chips are fabricated by CMOS processes with high noise immunity and low power consumption.

The LEDs can be the type of surface-mounted (SMT), the flat package or the R, G, B colors.

Because each of the circuit boards of the cable light has the LED driving chip, each LED mounted on the circuit boards can be separated controlled to generate a dynamic visual effect of light chasing. With the operation of the controller, the flexible cable light provides a variety of visual effects. Since each LED driving chip includes a serial shift register and an output register, the control signals can be repeated. With the flexible material, the cable light can be bent to form any shape. Because the power wires of the circuit boards are connected in parallel between the two strand wires and each adjacent two circuit boards are further connected in parallel with the power wires, the flexible cable light can be cut at the joint of two sets of the adjacent two circuit boards.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a flexible cable light in accordance with the present invention;

FIG. 2 is an exploded perspective view of the flexible cable light in FIG. 1;

FIG. 3 is an enlarged perspective cross sectional view in part of the flexible cable light of FIG. 2;

FIG. 4 is perspective cross sectional view of an inner coating of the flexible cable light of FIG. 1;

FIG. 5 is a perspective view of circuit boards to be mounted in the flexible cable light of FIG. 1;

FIG. 6 is a circuit diagram of the flexible cable light of FIG. 1;

FIG. 7 is a perspective view of a second embodiment of a flexible cable light in accordance with the present invention;

FIG. 8 is a perspective view of a conventional light; and

FIG. 9 is an operational view of forming a pattern using multiple flexible cable lights in accordance with the present invention.

### DETAILED DESCRIPTION OF THE PREFERRED EMBODIMENT

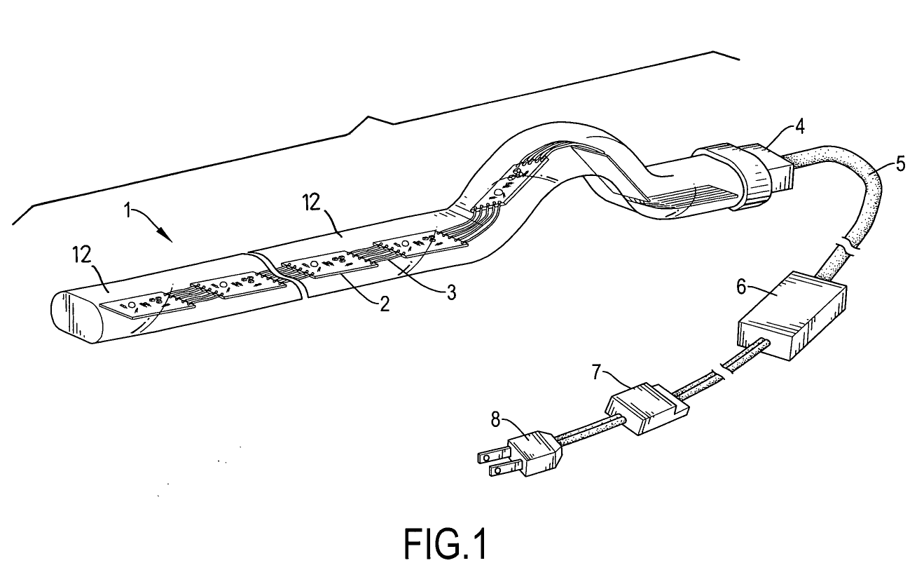

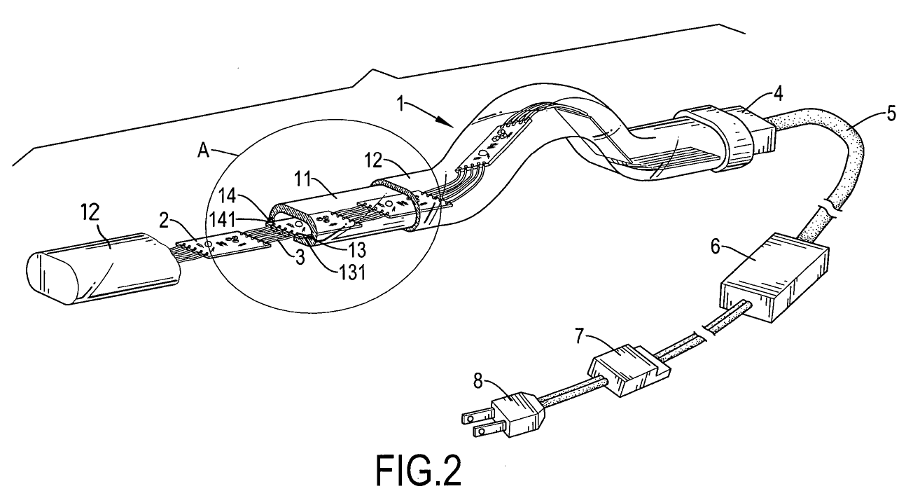

With reference to FIGS. 1 to 3, the flexible cable light is composed of an inner coating (11), multiple circuit boards (2), an outer coating (12), a connector (4), a cable (5), a controller (6), a power regulator (7) and a plug (8).

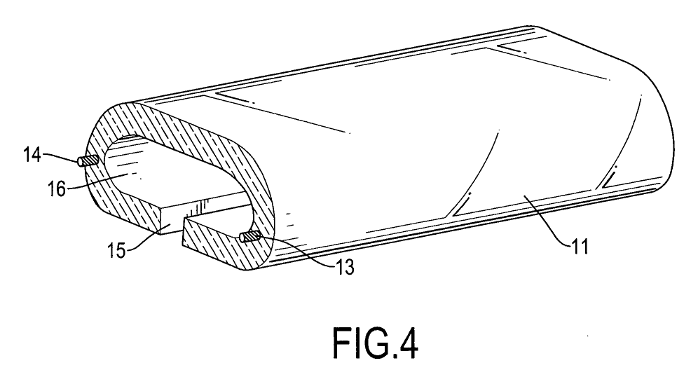

The inner coating (11) and the outer coating (12) form a light body (1) of the flexible cable light. With reference to FIG. 4, the inner coating (11) is made of flexible transparent material, and shaped as a long strip through the extruding processes. A space (16) is defined in the inner coating (11) and communicates with a longitudinal slot (15) defined through the bottom of the inner coating (11). Two strand wires (13,14) are mounted in opposite sides of the inner coating (11).

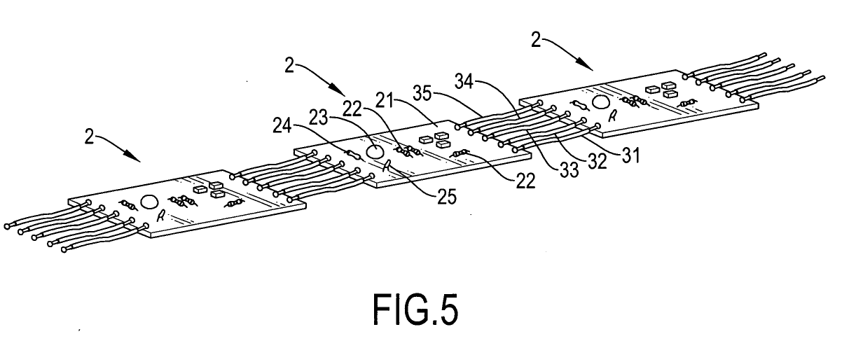

With further reference to FIG. 5, the multiple circuit boards (2) are connected as a string and held in the inner coating (11) through the longitudinal slot (15). Each circuit board (2) has multiple LEDs (21), current limiting resistors (22) and at least one LED driving chip (23), which are all mounted on the same surface of the circuit board (2). In this embodiment, three LEDs (21), three current limiting resistors (22) and an LED driving chip (23) on the circuit board (2) collectively form a basic module. Depending on different applications, more than one basic module can be formed on the same circuit board (2) to increase the density of LEDs.

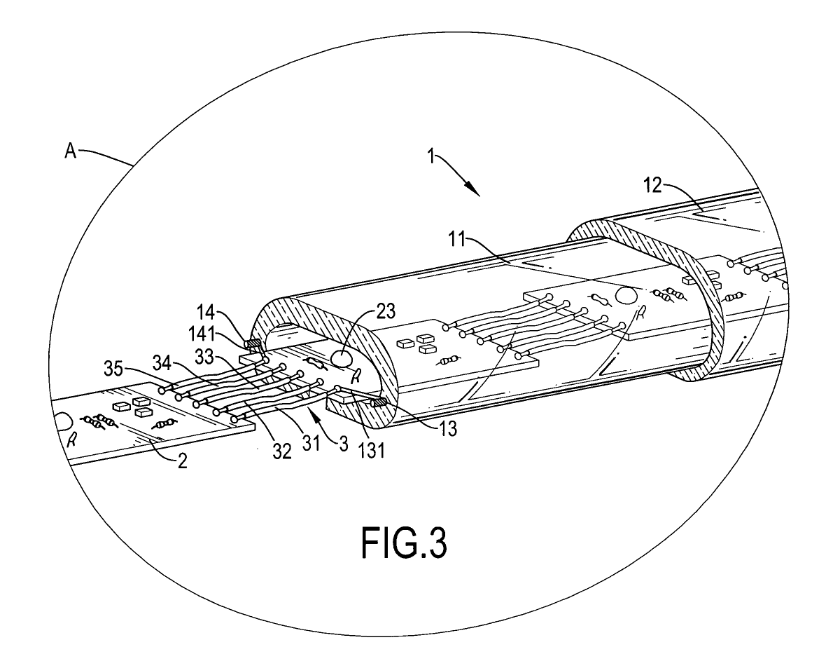

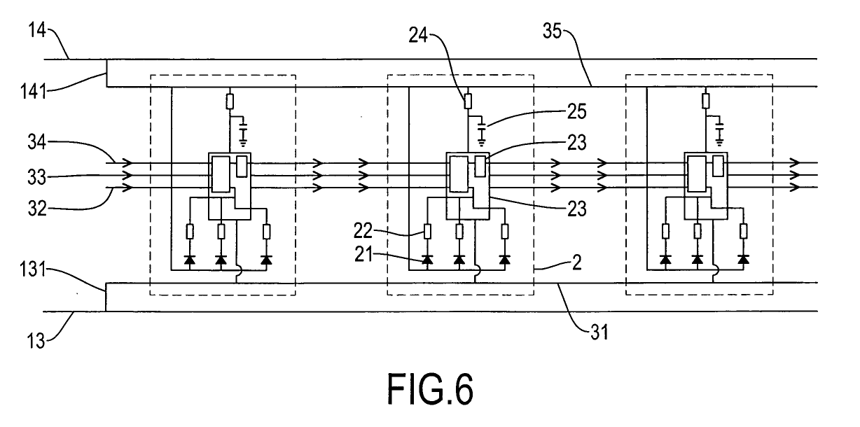

The circuit boards (2) are connected in series with a wire bundle (3). The wire bundle (3) is composed of power wires (31, 35) and signal wires (32, 33,34), wherein signal wires (32, 33,34) include a clock signal (CLK) wire (32), an enable signal wire (33) and a data wire (34). Each circuit board (2) has main power wires. Through the power wires (31,35), the main power wires of two adjacent circuit boards (2) are connected in parallel to the main power wires of another two adjacent circuit boards (2). With reference to FIGS. 3 and 6, the power wires (31, 35) are respectively connected to the two strand wires (13,14) through two conductive wires (131, 141). Therefore, the circuit boards (2) are connected in parallel between the two strand wires (13, 14). All LED driving chips (23) of the circuit boards (2) are connected in series by the signal wires (32, 33, 34). The string of circuit boards (2) is further connected to the controller (6) through the connector (4) and the cable (5). The cable (5) comprises the signal wires and power wires.

To stabilize the light emitted from the LEDs (21) and prolong the using life of the LEDs (21), each circuit board (2) can further have a voltage regulating resistor (24) and a capacitor (25). The voltage regulating resistor (24) and the capacitor (25) provide a voltage stabilizing and protecting effect. The circuit boards (2) connected in series and all wires (31-35) are all enclosed in the inner coating (11) through the longitudinal slot (15). The inner coating (11) with the circuit boards (2) is further held in the outer coating (12) to form the light body (1). The outer coating (12) and the inner coating (11) have the same length.

With reference to FIG. 6, the LED driving chip (23) are connected in series and each LED driving chip (23) is able to provide three outputs with large current driving ability. The LED driving chip (23) comprises a serial shift register and an output register, and is fabricated by CMOS processes with advantages of high noise immunity and low power consumption. Because the power regulator (7) supplies a stable DC voltage to the two strand wires (13,14), all circuit boards (2) can receive the same stable DC voltage.

When the controller (6) outputs control signals to the LED driving chip (23) of the first circuit board (2), data signal is input to the serial shift register of the LED driving chip (23). The serial shift register outputs a 3-bit signal to respectively drive the three LEDs (21) on the first circuit board (2). Furthermore, the 3-bit signal is simultaneously input to the output register that passes the 3-bit signal to a subsequent circuit board (2). The operations of the serial shift register and the output register are all controlled by the clock signal (CLK), and are activated by rising edges of the clock signal.

In the present invention, in addition to the driving signal for the LEDs, the LED driving chip also uses the driving signal as an input signal for a subsequent LED driving chip on the next circuit board. The subsequent circuit board enhances and repeats the received input signal by the DC voltage and to drive the LEDs and continue to transmit its driving signal to the next circuit board. The whole circuit of the present invention solves the problem of long-distance signal transmission by enhancing and repeating driving signal at each circuit board.

Different kinds of LEDs (21) can be used in the present invention. For example, the LEDs (21) can be the surface-mounted (SMT) type, the flat package type, or the R, G, B colors LEDs.

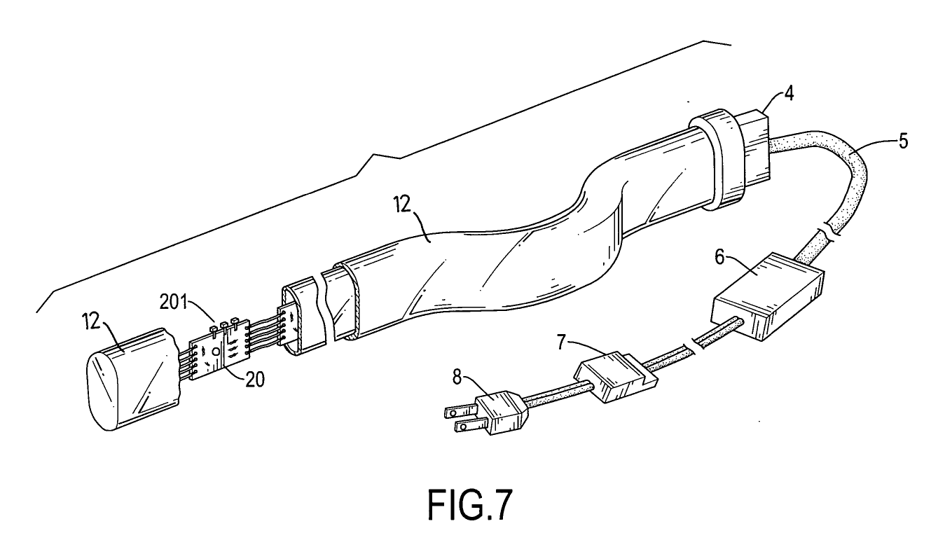

With reference to FIG. 7, all circuit boards (20) can be vertically held in the inner coating (11), wherein the LEDs (201) are the flat package type and electrically jointed on the surface of circuit board (20). The leads of the LEDs (201) on the circuit board (20) are upwardly bent to make the LEDs (201) vertically stand on the circuit board.

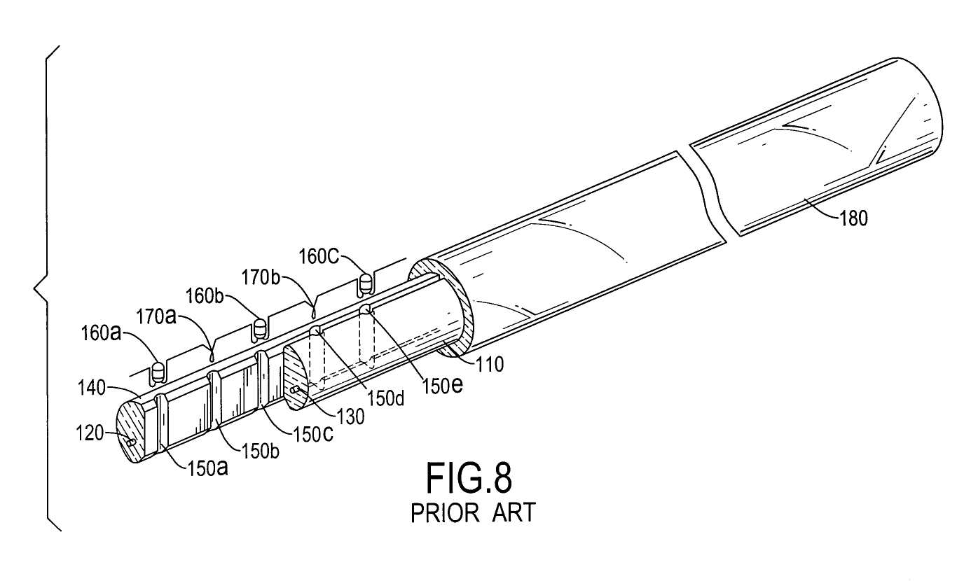

With reference to FIG. 8, a conventional light is composed of a transparent inner core (110), at least two power wires (120,130) mounted in the inner core (110), multiple vertical holes (150a, 150b, 150c, 150d, 150e) defined through the inner core (110) to hold the light bulbs (160a, 160b, 160c) and connecting wires (170a, 170b) of the light bulbs (160a, 160b, 160c). The connecting wires (170a, 170b) are electrically connected to the two power wires (120,130). The inner core (110) is then held in a transparent outer coating (180).

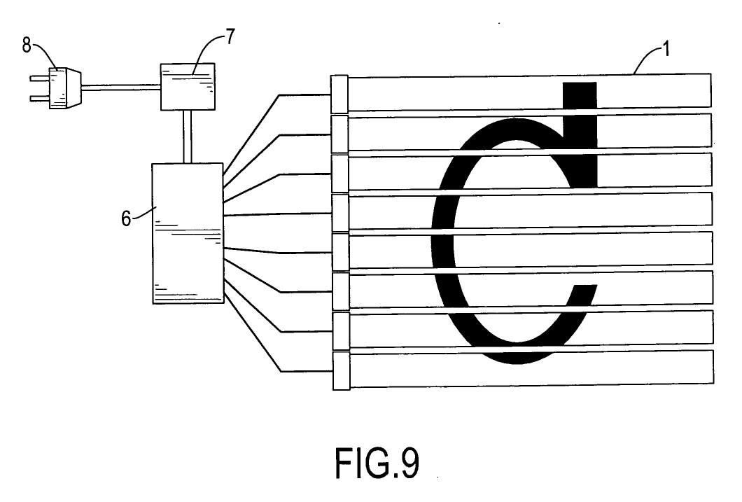

In one aspect, a single light body (1) of the present invention can be mounted at a desired position to decorate the outline of an object or generate the visual effect of flowing water. With reference to FIG. 9, in another aspect, arranging multiple light bodies (1) of the present invention can form a desired pattern or text with dynamic flowing effects. For example, a letter “C” is displayed by the light bodies (1).

The flexible cable light in accordance with the present invention can repeat the control signal at each circuit board. Therefore, multiple circuit boards with LEDs can be connected in series to generate the dynamic effect of flowing water. Further, the flexible cable light can be bent to form any desired shape or cut at a desired length according to the practical application.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A flexible cable light capable of generating a visual effect of flowing water, the flexible cable light comprising:
an inner coating made of flexible and transparent material and having a bottom and opposite side walls extending from the bottom, a space defined in the inner coating and communicating with a longitudinal slot that is defined through the bottom of the inner coating, two strand wires mounted in the opposite side walls; and
multiple circuit boards connected as a string with a wire bundle and held in the inner coating, each circuit board having multiple light emitting diodes (LEDs), multiple current limiting resistors and at least one LED driving chip, wherein power wires of the multiple circuit boards are connected in parallel between the two strand wires, and signal wires of the multiple circuit boards are connected in series to be further connected to a controller; and
an outer coating made of flexible and transparent material, wherein the inner coating and the multiple circuit boards are all held in the outer coating.

2. The flexible cable light as claimed in claim 1, wherein the LED driving chips can be connected in series to provide three large driving currents, and each LED driving chip comprises a serial shift register and an output register.

3. The flexible cable light as claimed in claim 1, wherein each circuit board has main power wires, and the main power wires of two adjacent circuit boards are connected in parallel to the main power wires of another two adjacent circuit boards.

4. The flexible cable light as claimed in claim 1, wherein each circuit board further having a voltage regulating resistor and a capacitor.

5. The flexible cable light as claimed in claim 1, wherein the LED driving chips are fabricated by CMOS processes with high noise immunity and low power consumption.

6. The flexible cable light as claimed in claim 1, wherein the LEDs are a type of surface-mounted (SMT).

7. The flexible cable light as claimed in claim 1, wherein the LEDs are a type of flat package.

8. The flexible cable light as claimed in claim 1, wherein the LEDs are a type of R, G, B colors.
